(19) United States
(12) Patent Application Publication
(10) Pub. No.: US 2016/0160817 A1
(43) Pub. Date: Jun. 9, 2016

(54) INTAKE SYSTEM

(71) Applicant: Hyundai Motor Company, Seoul (KR)

(72) Inventor: Won Rok Choi, Seoul (KR)

(73) Assignee: Hyundai Motor Company, Seoul (KR)

(21) Appl. No.: 14/822,072

(22) Filed: Aug. 10, 2015

(30) Foreign Application Priority Data
Dec. 9, 2014 (KR) 10-2014-0175841

(51) Int. Cl. F02M 35/10; F02B 29/04; F02D 41/00; F02M 35/104

(52) U.S. Cl. CPC F02M 35/10255; F02M 35/1045; F02B 29/0406; F02M 35/10072; F02B 29/0437; F02D 41/0002

(57) ABSTRACT

An intake system may include an intercooler to cool air supplied to an engine, an intake manifold to supply the air that is introduced from the intercooler into at least one cylinder and having a first runner and a second runner, an air control valve disposed between the intercooler and intake manifold and configured to control a flow rate or a path of the cooled air supplied to the intake manifold, and an air line to supply the air to the air control valve and feed the air that is introduced from the air control valve to the intake manifold, in which the air that is introduced from the intercooler is supplied to at least one of the first runner and the second runner, and at least one cylinder which is communicated with the first runner is separated from at least one cylinder which is communicated with the second runner.

### CROSS-REFERENCE TO RELATED APPLICATION

The present application claims priority to Korean Patent Application No. 10-2014-0175841 filed Dec. 9, 2014, the entire contents of which is incorporated herein for all purposes by this reference.

### BACKGROUND OF THE INVENTION

1. Field of the Invention

The present invention relates to an intake system. More particularly, the present invention relates to an intake system which is configured to feed air into each cylinder through branched passages of the intake manifold by controlling air supplied into the intake manifold by an air control valve.

2. Description of Related Art

In general, a diesel engine is provided with a turbo charger and an intercooler to obtain large output. The diesel engine with a turbo charger receives more external air by a compressor.

At this time, the external air received is compressed at a high temperature by heat generated in the compression process. Because this compressed air of high temperature (“supercharged air”) is a low density, when the supercharged air is supplied to the engine the charging efficiency of the engine drops.

Therefore, the engine may be provided with an intercooler to cool the supercharged air or to increase the density.

The intercooler is classified into an air-cooling intercooler and a water-cooling intercooler. The air-cooling intercooler is designed as a similar structure to that of a radiator. The air-cooling intercooler cools the supercharged air supplied to an engine using air flowing into a vehicle engine while the vehicle is running The water-cooling intercooler is an apparatus which cools the supercharged air using a coolant. The water-cooling intercooler has a merit of a higher responsiveness and cooling efficiency than the air-cooing intercooler.

A cooled air that is passed through the intercooler is supplied to the engine via the intake manifold.

The intake manifold can be integrally formed with the intercooler. The intake manifold formed integrally with intercooler has a merit of high cooling efficiency because the cooled air is directly supplied to the engine passing through the intake manifold. However, this intake manifold which is formed integrally with intercooler has a problem in that an intake interference, because the intake manifold is communicated with all the cylinders. And it is difficult to supply the air to each cylinder equally.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus and a method for controlling cooling capable of optimizing cooling performance by variably controlling an idle revolution per minute (RPM) depending on an outdoor temperature.

Additionally, various aspects of the present invention are directed to providing an intake system having advantages of improving cooling performance and efficiency by controlling the flow rate or the path of an air by an air control valve in accordance with an ignition order of each cylinder and passing the air through a separate path to each cylinder.

According to various aspects of the present invention, an intake system may include an intercooler configured to cool an air supplied to an engine, an intake manifold configured to supply the air that is cooled and introduced from the intercooler into at least one cylinder and having a first runner and a second runner, an air control valve disposed between the intercooler and the intake manifold and configured to control a flow rate or a path of the cooled air supplied to the intake manifold, and an air line configured to supply the air to the air control valve and feed the air that is introduced from the air control valve to the intake manifold, in which the air that is introduced from the intercooler is supplied to at least one of the first runner and the second runner, and at least one cylinder which is communicated with the first runner is separated from at least one cylinder which is communicated with the second runner.

The intercooler may be a water-cooling intercooler configured to cool the air by exchanging heat with a coolant.

The first runner may have a first cylinder, and a forth cylinder, the second runner may have a second cylinder, and third cylinder, in which the first cylinder and the forth cylinder may be disposed to be symmetric in a length direction of the air line, respectively, the second cylinder and the third cylinder may be disposed to be symmetric in a length direction of the air line, respectively,

The first runner and the second runner may be symmetric in a length direction of the air line, respectively.

The air control valve may include an opening portion and a closing portion, and the opening portion may be formed in such a shape that the air is allowed to pass therethrough, and the closing portion may be formed in such a shape that the air is blocked from passing therethrough.

The opening portion may be configured to communicate with the first runner or the second runner selectively, and when the opening portion is communicated with the first runner, the closing portion may be connected with the second runner, and when the opening portion is communicated with the second runner, then the closing portion may be connected with the first runner.

The air control valve may be rotatable, and when the air control valve revolves, positions of the opening portion and the closing portion may be exchangeable.

A cross section of the air control valve may be in a circle shape, the opening portion and the closing portion may be in a semicircle shape which is half of a cross-section of the air control valve, respectively.

The intake system may further include a controller that is configured to control the control valve in accordance with an ignition order of cylinders.

When there is an ignition in a cylinder that is communicated with the first runner, the controller may be configured to control rotation of the air control valve so that the opening portion is connected with the first runner.

When there is an ignition in a cylinder that is communicated with the second runner, the controller may be configured to control rotation of the air control valve so that the opening portion is connected with the second runner.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram illustrating that an air is supplied into a first runner according to the present invention.

FIG. 2 is a schematic diagram illustrating that an air is supplied into a second runner according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

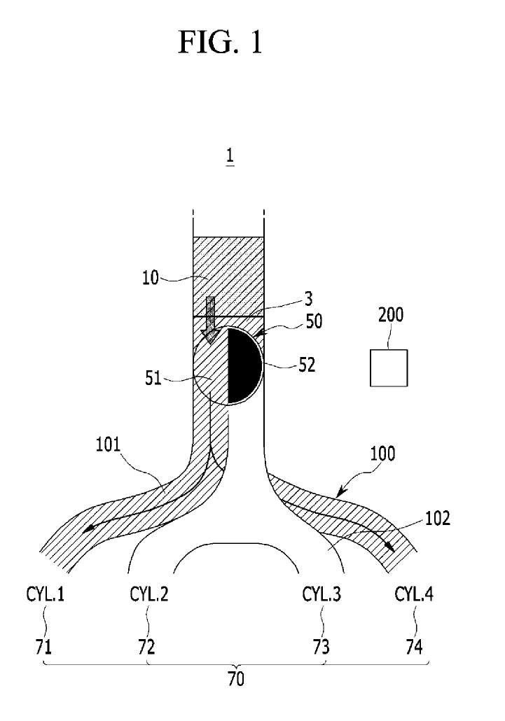

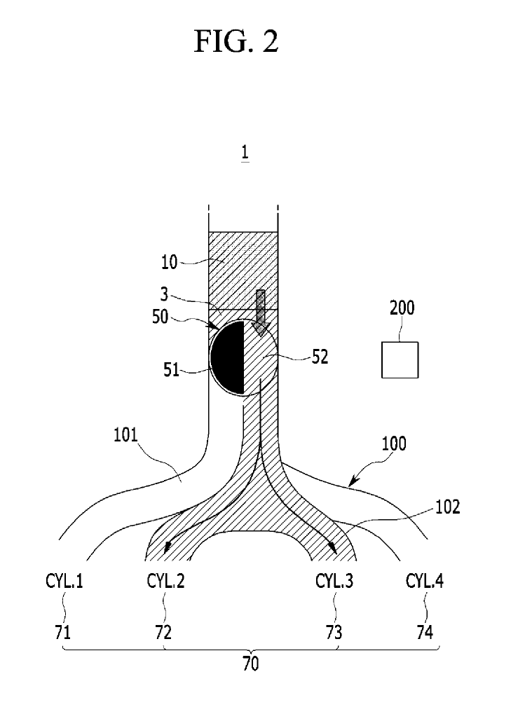

FIG. 1 is a schematic diagram so that an air is supplied into a first runner according to various embodiments of the present invention and FIG. 2 is a schematic diagram so that an air is supplied into a second runner according to various embodiments of the present invention.

As illustrated in FIGS. 1 and 2, an intake system 1 according to various embodiments of the present invention is configured to control a flow rate or a path of an air supplied to each cylinder. The intake system 1 includes an intercooler 10, an air control valve 50, and an intake manifold 100. The intercooler 10, the air control valve 50, and the intake manifold 100 are connected by an air line 3.

The intercooler 10 cools a compressed air supplied into an engine, and feeds the cooled air into an air control valve 50. The intercooler 10 may be a water-cooling intercooler configured to cool an air by exchanging heat with coolant, but is not limited thereto.

The air control valve 50 may supply an air that is introduced from the intercooler 10 into the intake manifold 100 according to an ignition order of the engine by controlling a flow rate or a path of the air. The air control valve 50 may be rotatably mounted to the inside of the air line 3. In other word, air control valve 50 is configured to rotate in a clockwise or a counterclockwise direction based on a left-right axis or an un-down axis in a drawing. Positions of an opening portion 51 and a closing portion 52 may be exchanged by revolving the air control valve 50.

A cross section of the air control valve 50 may be in a circle or an ellipse shape, but is not limited thereto.

This air control valve 50 includes the opening portion 51 and the closing portion 52.

As shown in FIG. 1, when the cross section of the air control valve 50 is in a circular shape, the opening portion 51 and the closing portion 52 may be respectively in a semicircular shape, but is not limited thereto. The opening portion 51 is formed in a shape that an air is allowed to pass through, and the closing portion 52 is formed in a shape that an air is blocked to pass through.

Therefore, the air seeded to the air control valve 50 passes through only the opening portion 51 which is opened up and down direction in drawing.

The intake manifold 100 supplies the air passed through the air control valve 50 to each cylinder 70. The intake manifold 100 includes the first runner 101 and the second runner 102.

The first runner or the second runner may selectively communicate with the opening portion 51 or the closing portion 52, respectively. In other words, when the opening portion 51 is communicated with the first runner, the closing portion 52 is connected with the second runner. And when the opening portion 51 is communicated with the second runner 102, the closing portion 52 is connected with the first runner 101.

The air passed through the first runner 101 or the second runner 102 is supplied to at least one cylinder 70. As shown in FIG. 1, the first runner 101 may be connected with the first cylinder 71 and the fourth cylinder 74 by air line 3. And the second runner 102 may be connected with the second cylinder 72 and the third cylinder 73 by air line 3. Meanwhile, the first runner 101 and the second runner 102 are respectively symmetric in a length direction of the air line 3. Therefore, the air passed through the first runner 101 or the second runner 102 supplied to each cylinder 70 equally.

The intake system 1 further includes a controller 200 to control the air control valve 50. The controller 200 can be realized by one or more processors activated by a predetermined program.

The controller 200 controls an amount of rotation of the air control valve 50 based on information about the ignition order of the cylinder.

FIG. 1 shows the intake system 1 when there is an ignition in a cylinder 70 connected with the first runner 101. In this instance, the controller 200 controls the air control valve 50 so that the opening portion 51 is connected with the first runner by rotating the air control valve 50 in a clockwise or counterclockwise direction. For this reason, the air passed through the opening portion 51 of the air control valve 50 is sent to the first cylinder 71 and the fourth cylinder 74 equally. In addition, the air supplied into the second runner 102 is blocked by the closing portion 52.

FIG. 2 shows the intake system 1 when there is an ignition in a cylinder 70 connected with the second runner 102. In this instance, the controller 200 controls the air control valve 50 so that the opening portion 51 is connected with the second runner by rotating the air control valve 50 in a clockwise or counterclockwise direction. For this reason, the air passed through the opening portion 51 of the air control valve 50 is sent to the second cylinder 72 and the third cylinder 73. In addition, the air supplied into the first runner 101 is blocked by the closing portion 52.

As described above, the air can be selectively supplied to the first runner or the second runner separately in accordance with an ignition order of each cylinder. Therefore, the engine efficiency can be equal to the conventional art despite relatively a small amount of an air.

In detail, in a conventional intake system, an air should be supplied to all the cylinders 70 such as the first, second, third, and fourth cylinders 71, 72, 73, and 74. However, according to a present invention, the air could be supplied only to the first and fourth cylinders 71, 74 or the second and third cylinders 72, 73.

Since an air flow required for cylinder 70 is reduced, even if the intercooler 10 capacity is less than the conventional intake system, the cooling performance can be maintained. And a size of the turbo charger can be small. Therefore, a cost of the intercooler 10 and the turbo charger can be reduced.

Furthermore, since the intake manifold 100 configured to supply the air to each cylinder 70 is branched off to the first runner 101 and the second runner 102. And the air is supplied into one of the runners 101, 102, the present invention could moderate an intake gas interference than when supplying the air into all of the runners 101, 102.

As described above, according to various embodiments of the present invention, as the air control valve 50 disposed at the intake manifold 100 controls the flow rate and path of the air, the present invention has an effect to minimize the intake gas flow interference and optimize intake efficiency. Moreover, since the air supplied to intake manifold 100 is controlled appropriately, the intercooler 10 and the turbo charger can be downsized. Thus, the cost thereof can be reduced.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An intake system, comprising:
an intercooler configured to cool an air supplied to an engine;
an intake manifold configured to supply the air that is cooled and introduced from the intercooler into at least one cylinder and having a first runner and a second runner;
an air control valve disposed between the intercooler and the intake manifold and configured to control a flow rate or a path of the cooled air supplied to the intake manifold; and
an air line configured to supply the air to the air control valve and feed the air that is introduced from the air control valve to the intake manifold,
wherein the air that is introduced from the intercooler is supplied to at least one of the first runner and the second runner, and
at least one cylinder which is communicated with the first runner is separated from at least one cylinder which is communicated with the second runner.

2. The intake system of claim 1, wherein the intercooler is a water-cooling intercooler configured to cool the air by exchanging heat with a coolant.

3. The intake system of claim 1, wherein the first runner has a first cylinder, and a forth cylinder,
the second runner has a second cylinder, and a third cylinder,
wherein the first cylinder and the forth cylinder are disposed to be symmetric in a length direction of the air line, respectively,
the second cylinder and the third cylinder are disposed to be symmetric in the length direction of the air line, respectively,

[symbol]

4. The intake system of claim 1, wherein the first runner and the second runner are symmetric in a length direction of the air line, respectively.

5. The intake system of claim 1, wherein the air control valve includes an opening portion and a closing portion, and
the opening portion is formed in a shape that the air is allowed to pass therethrough, and
the closing portion is formed in a shape that the air is blocked from passing therethrough.

6. The intake system of claim 5, wherein the opening portion is configured to communicate with the first runner or the second runner selectively, and
when the opening portion is communicated with the first runner, the closing portion is connected with the second runner, and
when the opening portion is communicated with the second runner, then the closing portion is connected with the first runner.

7. The intake system of claim 6, wherein the air control valve is rotatable, and
when the air control valve revolves, positions of the opening portion and the closing portion are exchangeable.

8. The intake system of claim 7, wherein a cross section of the air control valve is in a circle shape,
the opening portion and the closing portion are in a semicircle shape which is half of a cross-section of the air control valve, respectively.

9. The intake system of claim 7, further comprising a controller that is configured to control the control valve in accordance with an ignition order of cylinders.

10. The intake system of claim 9, wherein, when there is an ignition in a cylinder that is communicated with the first runner, the controller is configured to control rotation of the air control valve so that the opening portion is connected with the first runner.

11. The intake system of claim 10, wherein, when there is an ignition in a cylinder that is communicated with the second runner, the controller is configured to control rotation of the air control valve so that the opening portion is connected with the second runner.
